(19) United States
(12) Patent Application Publication
(10) Pub. No.: US 2026/0264637 A1
(43) Pub. Date: Sep. 10, 2026

(54) SEAT BACK OR SEAT CUSHION

(71) Applicant: TOYOTA BOSHOKU KABUSHIKI KAISHA, Aichi-ken (JP)

(72) Inventor: Masahiko IYODA, Aichi-ken (JP)

(73) Assignee: TOYOTA BOSHOKU KABUSHIKI KAISHA, Aichi-ken (JP)

(21) Appl. No.: 19/545,596

(22) Filed: Feb. 20, 2026

(30) Foreign Application Priority Data
Mar. 4, 2025 (JP) 2025-033548

(51) Int. Cl. B60R 21/207; B60N 2/56; B60N 2/58; B60N 2/64

(52) U.S. Cl. CPC B60R 21/207; B60N 2/5621; B60N 2/5883; B60N 2/64

(57) ABSTRACT

A seat back or seat cushion includes a frame defining a framework and a cushion structure attached to the frame to elastically support a seated occupant. The cushion structure includes a main structure located at a central portion in a seat width direction and a pair of left and right side structures disposed on opposite sides of the main structure. The main structure comprises a main pad covered by a main cover, and each side structure includes a side pad covered by a side cover. A planar member is positioned in close contact to bridge the main structure and the side structures along a surface of the cushion structure facing the frame.

### CROSS-REFERENCE TO RELATED APPLICATION

This application claims priority to Japanese patent application serial number 2025-33548 filed Mar. 4, 2025, the contents of which are incorporated herein by reference in its entirety for all purposes.

### TECHNICAL FIELD

The present disclosure relates to a seat back or a seat cushion.

### BACKGROUND

Conventionally, there has been known a seat back or a seat cushion for a vehicle seat equipped in an automobile or other vehicle, in which a seat pad covered with a seat cover is divided into three parts in a seat width direction and attached to a seat frame. For example, a prior art disclose a seat cushion in which a seat cushion main part in the center of the seat width direction and seat cushion side parts disposed on the sides of the seat cushion main part are attached to the seat cushion frame. Such a vehicle seat has good ease of assembly and is easily compatible with automation of assembly. In addition, it is easy to replace only the seat cushion side parts, which tends to deteriorate when a seated occupant gets on and off.

According to the vehicle seat described in the above prior art, the seat cushion main part and the seat cushion side part are formed by placing pads on respective resin support members, covering them from above with a cover, and securing the end of the cover to the underside of the support members. When the seat cushion main part and the seat cushion side part are attached to the cushion frame, there is a risk that foreign objects may enter the space inside the seat cushion between them.

Therefore, an object of the present disclosure is to prevent foreign objects from entering the interior through gaps formed between divided parts in the seat back or the seat cushion, in which the seat pad covered with the seat cover is divided into three parts in the seat width direction and attached to the seat frame.

### SUMMARY

An aspect of the present disclosure provides a seat back or a seat cushion including a frame defining a framework, and a cushion structure attached to the frame and configured to elastically support a seated occupant. The cushion structure includes a main structure located at a central portion in a seat width direction, and a pair of left and right side structures positioned on opposite sides of the main structure. The main structure includes a main pad serving as a cushion body, and a main cover covering the main pad. Each of the side structures includes a side pad serving as a cushion body, and a side cover covering the side pad. A planar member is disposed in close contact to bridge the main structure and the side structures along surface of the cushion structure facing the frame.

### BRIEF DESCRIPTION OF DRAWINGS

FIG. 1 is a perspective view of an automobile seat to which a seat back according to an embodiment is assembled.

FIG. 2 is an exploded perspective view of the seat back of FIG. 1.

FIG. 3 is a cross-sectional view taken along a line III-III in FIG. 1.

FIG. 4 is a corresponding figure to FIG. 3 of another embodiment.

FIG. 5 is a corresponding figure to FIG. 3 of yet another embodiment.

### DETAILED DESCRIPTION

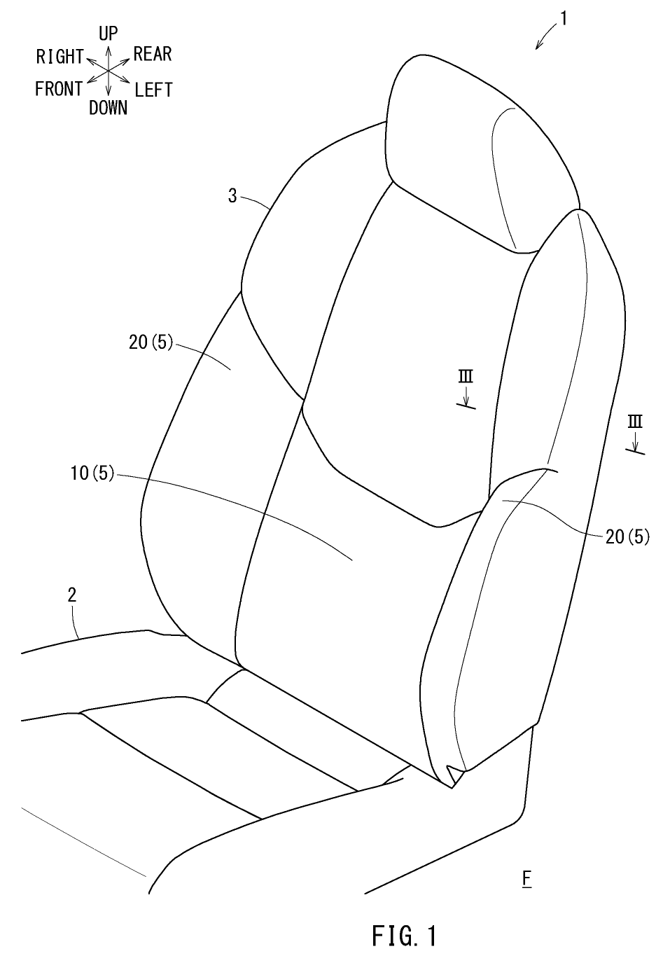

With reference to FIGS. 1 to 3, a seat back 3 of an automobile seat 1 according to an embodiment of the present disclosure will be described. In the following description, directional terms (e.g., up/down, front/rear, right/left) are based on the orientations shown in the respective figures. Specifically, the up/down, front/rear, and right/left directions are defined relative to the automobile seat 1 when the seat 1 is mounted on a floor F of the automobile. The right-left direction corresponds to a seat width (lateral) direction.

As shown in FIG. 1, the automobile seat 1 includes a seat cushion 2 configured to support the buttocks and thighs of a seated occupant and the seat back 3 configured to support the lower back (lumbar) and upper back of the seated occupant.

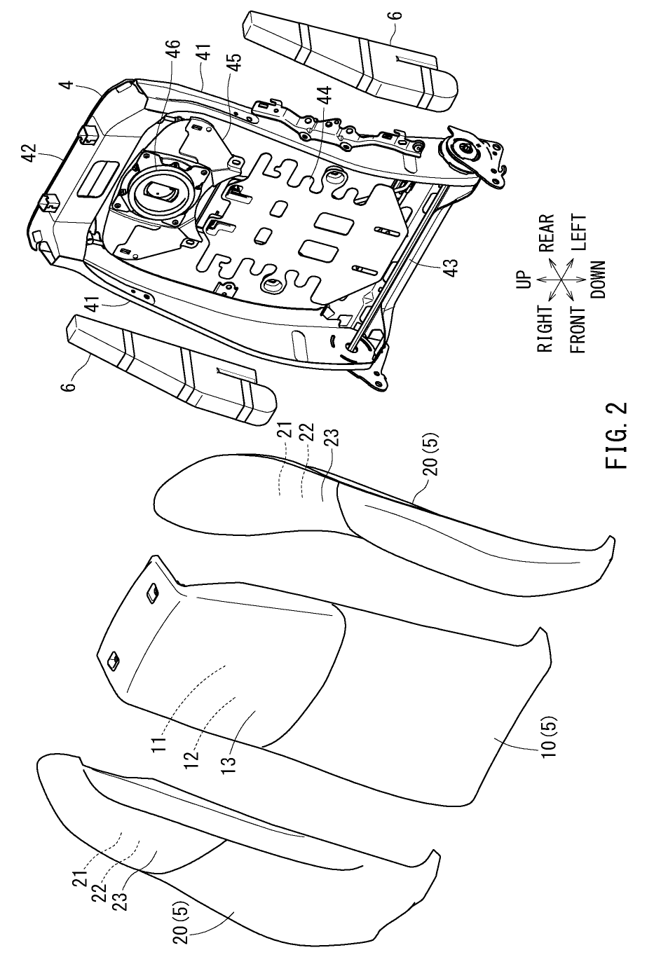

As shown in FIGS. 1 and 2, the seat back 3 includes a frame 4, a cushion structure 5, and a pair of left and right airbag devices 6. The frame 4 forms a framework of the seat back 3. The cushion structure 5, which is assembled to the frame 4, provides a cushioning function and defines the external shape of the seat back 3.

As shown in FIGS. 1 and 2, the frame 4 includes a pair of side frames 41, an upper frame 42, and a lower frame 43. The side frames 41 extend vertically along the right and left sides of the seat back 3. The upper frame 42 extends across the upper ends of the side frames 41, and the lower frame 43 extends across the lower ends of the side frames 41. The frame 4 has a substantially rectangular shape when viewed from the front. A lumbar plate 44 is arranged between the upper frame 42 and the lower frame 43. A fan 46 is attached to the frame 4 via a fan mounting plate 45 positioned between the upper frame 42 and the lumbar plate 44.

As shown in FIGS. 1 to 3, the cushion structure 5 includes a main structure 10 at a central portion in the seat width direction and a pair of left and right side structures 20 on opposite sides of the main structure 10. The main structure 10 supports the lower back and upper back of the seated occupant from the rear side. The side structures 20 support the lower back and upper back of the seated occupant from the sides.

The main structure 10 includes a main support member 11, a main pad 12, and a main cover 13. The main support member 11 is typically made of resin. The main pad 12 is a cushioning body disposed on the front side of the main support member 11 and is supported by the main support member 11 against the frame 4. The main cover 13 covers the main pad 12 from the front side.

The main support member 11 is fixed to the upper frame 42 at an upper rear surface thereof, to the lumbar plate 44 at a rear surface thereof at approximately the center in the vertical direction, and to the lower frame 43 at a lower rear surface thereof. The main support member 11 is configured such that a rear side thereof is supported by abutting against the fan mounting plate 45 and the lumber plate 44.

The main pad 12 is an elastic body made of a polyurethane resin foam molded body and has an outer shape substantially identical to that of the main support member 11 when viewed from the front. The main cover 13 is a bag-shaped cover member formed by sewing together multiple pieces and opens toward the rear. The main structure 10 is formed by placing the main cover 13 over the main pad 12 positioned in front of the main support member 11 from the front side and securing a rear opening end portion 13a to a rear surface of an outer peripheral edge of the main support member 11.

As shown in FIGS. 1 to 3, the side structure 20 includes a side support member 21, a side pad 22, and a side cover 23. The side support member 21 is made of resin. The side pad 22 is a cushioning body disposed on a front side of the side support member 21 and is supported by the side support member 21 relative to the frame 4. The side cover 23 covers the side pad 22 from the front.

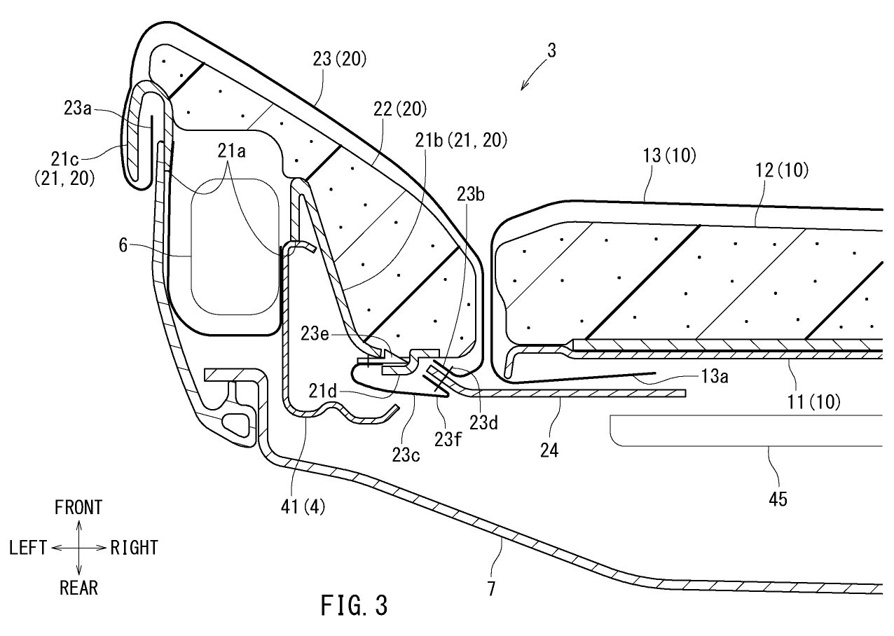

As shown in FIG. 3, the side support member 21 extends in a vertical direction. A through-hole 21a is formed in a substantially central portion of the side support member 21 in a left-right direction, the through-hole 21a extending in the vertical direction and penetrating in a front-rear direction. A right side of the through-hole 21a (an inboard side of the seat) constitutes a base portion 21b extending vertically along a front side of the side frame 41. A left side of the through-hole 21a (an outboard side of the seat) constitutes a deforming portion 21c. The deforming portion 21c has a substantially U-shaped horizontal cross section opening rearward. The airbag device 6 is fixed to and disposed on the side frame 41 on a rear side of the through-hole 21a. An engaging portion 21d is formed at a rear right side of the base portion 21b so as to open toward the left and to allow a carpet member 23c, described later, to be fastened from the left side.

As shown in FIG. 3, the side pad 22 is an elastic body formed of a polyurethane resin foam molded body and has an outer shape substantially the same as that of the side support member 21 when viewed from the front. A portion corresponding to the through-hole 21a of the side support member 21 is formed to cover the front portion of the airbag device 6 positioned to block the through hole 21a, and no hole extending in the front-rear direction is provided.

As shown in FIG. 3, the side cover 23 is a bag-shaped cover member formed by sewing a plurality of pieces together and having a rearward opening. The side structure 20 is formed by fitting the side cover 23 over the side pad 22 disposed on a front side of the side support member 21 from the front side. An outer end portion 23a, which is a left-side terminal portion of the rear opening, is fixed to the deforming portion 21c of the side support member 21, and an inner end portion 23b, which is a right-side terminal portion of the rear opening, is fixed to the base portion 21b of the side support member 21. Specifically, the outer end portion 23a is inserted from the rear and fixed inside the deforming portion 21c together with a resin plate (not shown) attached thereto by sewing. The inner end portion 23b is sewn together with a sewing thread 23d such that a left end of a planar member 24 and a right end of a carpet 23c are overlapped in this order at a sewing portion 23f. The planar member 24 is made of carpet and is flexible. The carpet member 23c includes a resin plate 23e having an arrowhead-shaped cross section, and a flat sewing portion 23f connected to the right side of the resin plate 23e. The resin plate 23e is rigid and stiff, whereas the sewing portion 23f is flexible. The resin plate 23e and the sewing portion 23f are integrated by sewing. The inner end portion 23b is fixed to the base portion 21b of the side support member 21 by engagement of the resin plate 23e of the carpet member 23c with the engaging portion 21d of the base portion 21b.

As shown in FIG. 3, the seat back 3 is assembled as follows. First, with the airbag device 6 fixed to the side frame 41 of the frame 4, the left and right side structures 20 are attached to the frame 4. At this time, the planar member 24 extends rightward (toward an interior side of the seat) so as to abut against a front surface of the fan mounting plate 45. In this state, the main structure 10 is attached to the frame 4 from the front. As a result, the side structures 20 and the main structure 10 come into contact with each other with slight interference in a left-right direction, and the planar member 24 is closely disposed in a bridging manner over a contact area between the side structures 20 and the main structure 10 from the rear. Finally, a backboard 7 is attached to the frame 4 from the rear so as to conceal the interior of the seat back 3. The seat back 3 assembled as described above is attached to the seat cushion 2, as shown in FIG. 1, to form an automotive seat 1, which is fixed to a floor F.

The present embodiment configured as described above achieves the following advantageous effects. The planar member 24 is closely disposed in a bridging manner between the main structure 10 and the side structure 20 on a rear surface (a surface facing the frame 4) of the cushion structure 5. Thereby, while allowing the main pad 12 of the main structure 10 and/or the side pad 22 of the side structure 20 to be compressed and deformed, it is possible to prevent foreign objects from entering an interior of the seat back 3 from between the main structure 10 and the side structure 20.

In addition, since a left end portion (an outer end portion in a seat width direction) of the planar member 24 is attached to an inner end portion 23b of the side cover 23 of the side structure 20, the planar member 24 can be attached simultaneously when the side structure 20 is mounted to the frame 4, thereby improving assembly efficiency. Further, since the planar member 24 is attached to the side cover 23 of the side structure 20, which is mounted to the frame 4 prior to the main structure 10, it is only necessary to mount the side structure 20 and then the main structure 10 to the frame 4, thereby further improving assembly efficiency.

Although certain embodiments have been described above, the present disclosure is not limited to the structures and configurations thereof, and various modifications, additions, and omissions may be made without departing from the spirit and scope of the present disclosure. Examples thereof include the following.

In the above embodiment, the present disclosure is applied to the seat back 3; however, the present disclosure may also be applied to the seat cushion 2.

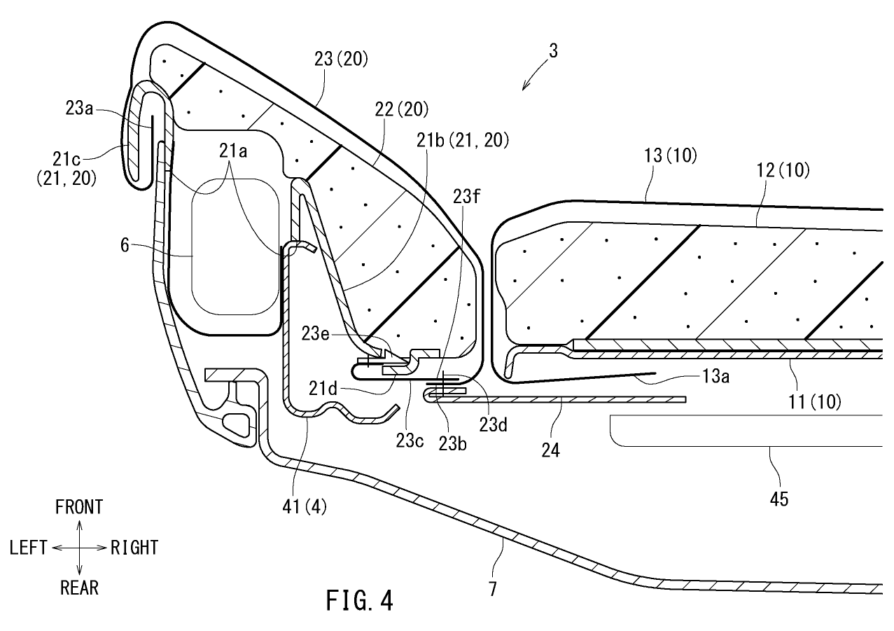

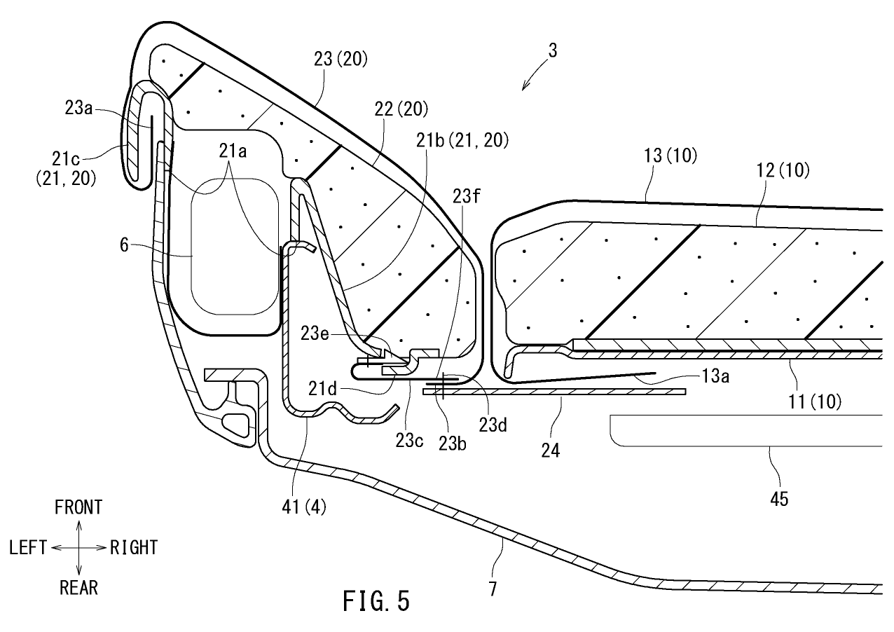

In the above embodiment, the inner end portion 23b of the side cover 23, the left end portion of the planar member 24, and the sewing portion 23f of the carpet member 23c are sewn together with the sewing thread 23d in an overlapped state as shown in FIG. 3. When the resin plate 23e of the carpet member 23c is engaged with the engaging portion 21d of the side support member 21, the sewing portion 23f of the carpet member 23c is folded. However, the present disclosure is not limited thereto. As shown in FIG. 4, the inner end portion 23b of the side cover 23, the left end portion of the planar member 24, and the sewing portion 23f of the carpet member 23c may be sewn together with the sewing thread 23d in a state where the left end portion of the planar member 24 is folded. Further, as shown in FIG. 5, the inner end portion 23b of the side cover 23, the left end portion of the planar member 24, and the sewing portion 23f of the carpet member 23c may be sewn together with the sewing thread 23d in a state where neither the left end portion of the planar member 24 nor the sewing portion 23f of the carpet member 23c is folded.

In the above embodiment, the present disclosure is applied to the automobile seat 1; however, the present disclosure may also be applied to seats for aircraft, ships, railway vehicles, and the like.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat back or seat cushion, and/or methods of making and using the same.

What is claimed is:

1. A seat back or seat cushion, comprising:
a frame defining a framework; and
a cushion structure attached to the frame and configured to elastically support a seated occupant, wherein the cushion structure comprises:
a main structure located at a central portion in a seat width direction; and
a pair of left and right side structures positioned on opposite sides of the main structure, wherein the main structure comprises:
a main pad functioning as a cushion body; and
a main cover covering the main pad, wherein each of the side structures comprises:
a side pad functioning as a cushion body; and
a side cover covering the side pad,
and wherein a planar member closely bridges the main structure and the side structures along a surface of the cushion structure facing the frame.

2. The seat back or seat cushion according to claim 1, wherein a portion of the planar member is attached to one of the main cover and the side cover.

3. The seat back or seat cushion according to claim 2, wherein the side structures are attached to the frame before the main structure, and
wherein the planar member is attached to the side cover.

4. The seat back or seat cushion according to claim 3, wherein each of the side structures further comprises a side support member configured to support the side pad relative to the frame, and wherein the side support member includes a base portion having an engaging portion formed thereon.

5. The seat back or seat cushion according to claim 4, further comprising a fastening member including a rigid plate and a flexible connecting portion, wherein an end portion of the side cover, an end of the planar member, and the flexible connecting portion are sewn together, and wherein the rigid plate is engaged with the engaging portion of the side support member to fix the side cover and the planar member to the side support member.

6. The seat back or seat cushion according to claim 4, wherein the side support member includes a through-hole penetrating in a front-rear direction, wherein an airbag device is attached to the frame on a rear side of the through-hole, and wherein the side pad covers a front side of the airbag device positioned to block the through-hole.

7. The seat back or seat cushion according to claim 1, wherein the main structure further comprises a main support member supporting the main pad relative to the frame, and wherein the main cover includes a rear opening end portion secured to a rear surface of the main support member.

8. The seat back or seat cushion according to claim 1, wherein the frame includes a fan mounting plate, and wherein the planar member extends toward an interior side of the seat back or seat cushion to abut against the fan mounting plate.

9. A seat back or seat cushion, comprising:
a frame; and
a side structure attached to the frame, the side structure including a side support member, a side pad supported by the side support member, and a side cover covering the side pad, wherein the side support member includes a base portion having an engaging portion, wherein an end portion of the side cover, an end of a planar member, and a fastening member are sewn together at a sewing portion, and wherein the fastening member engages with the engaging portion of the side support member to secure the side cover and the planar member to the side support member.

10. The seat back or seat cushion according to claim 9, wherein the fastening member comprises a resin plate having an arrowhead-shaped cross section and a flexible sewing portion connected to the resin plate, wherein the resin plate is engaged with the engaging portion, and wherein the flexible sewing portion is sewn to the end portion of the side cover and the end of the planar member.

11. The seat back or seat cushion according to claim 10, wherein the resin plate has a rigidity greater than that of the flexible sewing portion.

12. The seat back or seat cushion according to claim 10, wherein the end portion of the side cover, the end of the planar member, and the flexible sewing portion of the fastening member are overlapped in this order and sewn together at the sewing portion.

13. The seat back or seat cushion according to claim 9, wherein the side support member includes a through-hole penetrating in a front-rear direction, wherein the base portion is located on an inner side of the through-hole in the seat width direction, wherein the side support member further includes a deforming portion located on an outer side of the through-hole in the seat width direction, and wherein an outer end portion of the side cover is fixed to the deforming portion.

14. The seat back or seat cushion according to claim 13, further comprising an airbag device, wherein the airbag device is fixed to the frame on a rear side of the through-hole, and wherein the side pad is configured to cover a front portion of the airbag device.
